(19) United States
(12) Patent Application Publication
(10) Pub. No.: US 2017/0036361 A1
(43) Pub. Date: Feb. 9, 2017

(54) RAZOR HANDLE

(71) Applicant: Unicorn Theory, LLC, New York, NY (US)

(72) Inventor: Brian Craig BUSHELL, New York, NY (US)

(21) Appl. No.: 15/227,791

(22) Filed: Aug. 3, 2016

Related U.S. Application Data
(60) Provisional application No. 62/200,218, filed on Aug. 3, 2015.

(51) Int. Cl. B26B 21/52; B26B 21/06; B26B 21/14

(52) U.S. Cl. CPC B26B 21/521; B26B 21/14; B26B 21/06

(57) ABSTRACT

A razor handle that provides maximum control when shaving is disclosed. The handle base may have a rectangular prism or tetrahedral frustum shape, with one unique side surface for each of a user's three fingertips. The base naturally stands upright when not in use, thereby keeping the blade from making direct contact with wet surfaces for extended periods of time.

### CROSS REFERENCE TO RELATED APPLICATION

This application claims the benefit of U.S. Provisional Patent Application No. 62/200,218, filed Aug. 3, 2015, which is incorporated by reference herein in its entirety.

### FIELD OF THE INVENTION

The present invention relates to razor handles and razors used in shaving operations and, more particularly to a handle for facilitating a user's grip on the handle of a safety razor during shaving.

### BACKGROUND OF THE INVENTION

Razors with safety razor handles, which are in common use in the United States and elsewhere around the world, have a shaft that runs roughly the length of the user's hand and can be gripped in a variety of ways. Unfortunately, such safety razor handles often slip from a user's hand during use because conventional the safety razor handle's shaft makes contact with various points on the hand and fingers during use. However, contrary to expectation, the more surface area contact a hand makes with a handle during use, the less control the user has over the razor while shaving, due to the care and precision required for shaving using a razor.

In addition, due to the shaft-like design of their handles, safety razors are often laid to rest on flat, horizontal surfaces (counters or shelves) following their use. Because water is a common ingredient of shaving, safety razors are often wet when they are laid to rest on such surfaces and can remain wet for a meaningful period of time, until the “puddle” on the counter surface dries due to evaporation. This extended contact with water and other elements may expedite the deterioration of a razor's shaving edge, thereby shortening the razor's useful life.

It is desirable to provide a handle for a safety razor that addresses the above-identified problems and provides an alternative and/or improved razor handle.

### SUMMARY OF THE INVENTION

According to some embodiments of the present invention, there is provided a shaft-free safety razor blade handle with a unique surface area, or “grip surface,” for each of the three shaving fingertips. This invention also naturally stands upright when it is not in use, which keeps the shaving edge of the blade away from wet surfaces which may cause expedited deterioration of the blade due to extended contact with water and other elements.

According to certain embodiments of the present invention, there is provided a razor handle comprising a base having three connected side walls and a triangular top surface for mounting a razor cartridge.

In certain embodiments of the present invention, at least two of the three side walls are the same size. In other embodiments, all three side walls are the same size.

In certain embodiments of the invention, the base has a truncated tetrahedron shape. In certain embodiments, each of the three side walls has a bottom edge and a top edge, and the bottom edge of each of the three side walls is longer than the top edge of each of the three side walls. In certain embodiments, the base comprises a triangular bottom surface, and each side of the triangular bottom surface is larger than the corresponding side of the triangular top surface. In certain embodiments, each of the three side walls has a trapezoid shape.

In certain embodiments of the invention, the base has a triangular prism shape. In certain embodiments, at least one of the three side walls has a square shape. In certain embodiments, at least one of the three side walls has a rectangular shape. In certain embodiments, the base comprises a triangular bottom surface that is substantially the same size as the triangular top surface.

In certain embodiments of the invention, each of the three walls has a concave surface to aid in gripping by a user. In certain embodiments, at least one of the three sides comprises a high friction material disposed thereon.

In certain embodiments of the invention, each of the side walls forms an edge with another of the side walls, wherein the edges are either sharply defined or are rounded.

In certain embodiments of the invention, the base comprises a mechanism therein for allowing the razor cartridge to be selectively retained and released. In certain embodiments, the razor handle further comprises a connecting means for grasping the razor cartridge, which, in some embodiments, extends from the top surface of said base.

In certain embodiments of the invention, the razor handle further comprises a release button that, when pushed, causes the razor cartridge to be released from said connecting means. In some embodiments, the release button is located on a bottom surface of the base.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a top, front, right side perspective view of a razor handle, according to an embodiment of the invention;

FIG. 1B is a front elevation view of the razor handle, according to an embodiment of the invention;

FIG. 1C is a left side elevation view of the razor handle, according to an embodiment of the invention;

FIG. 1D is a top plan view of the razor handle, according to an embodiment of the invention;

FIG. 1E is a bottom plan view of the razor handle, according to an embodiment of the invention;

FIG. 2 is a schematic view of an exemplary release mechanism inside of a razor handle, according to an embodiment of the invention;

FIG. 3 is an illustrative example of a user's fingers grasping a razor handle shown without a safety razor attached, according to an embodiment of the invention; and

FIG. 4 is an illustrative example of a user's fingers grasping a razor handle shown with an attached safety razor, according to an embodiment of the invention;

It is appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will be apparent to one skilled in the art that the present invention may be practiced without the specific details presented herein. Furthermore, well known features may be omitted or simplified in order not to obscure the present invention.

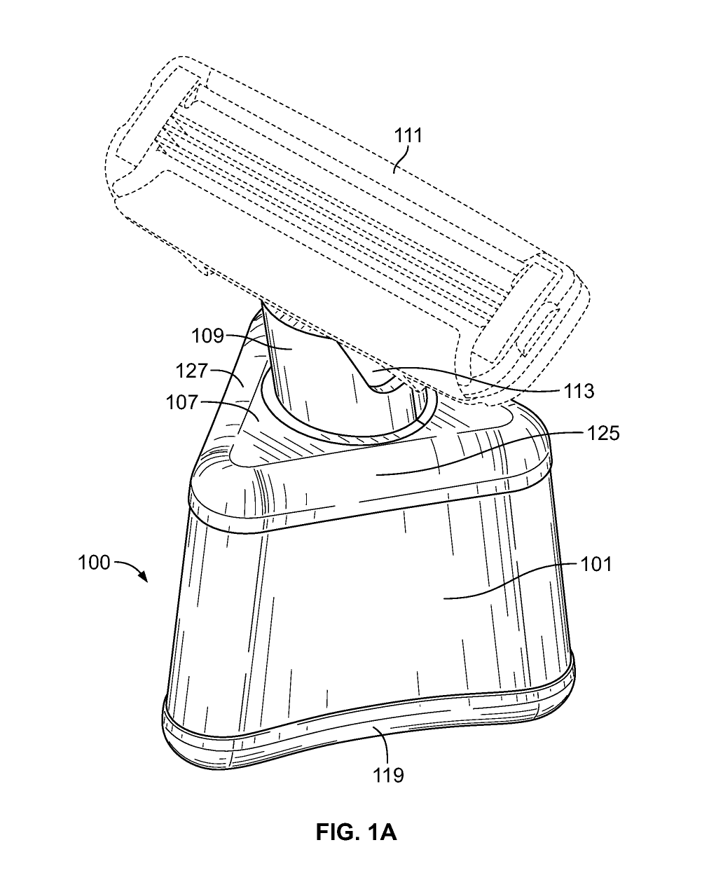

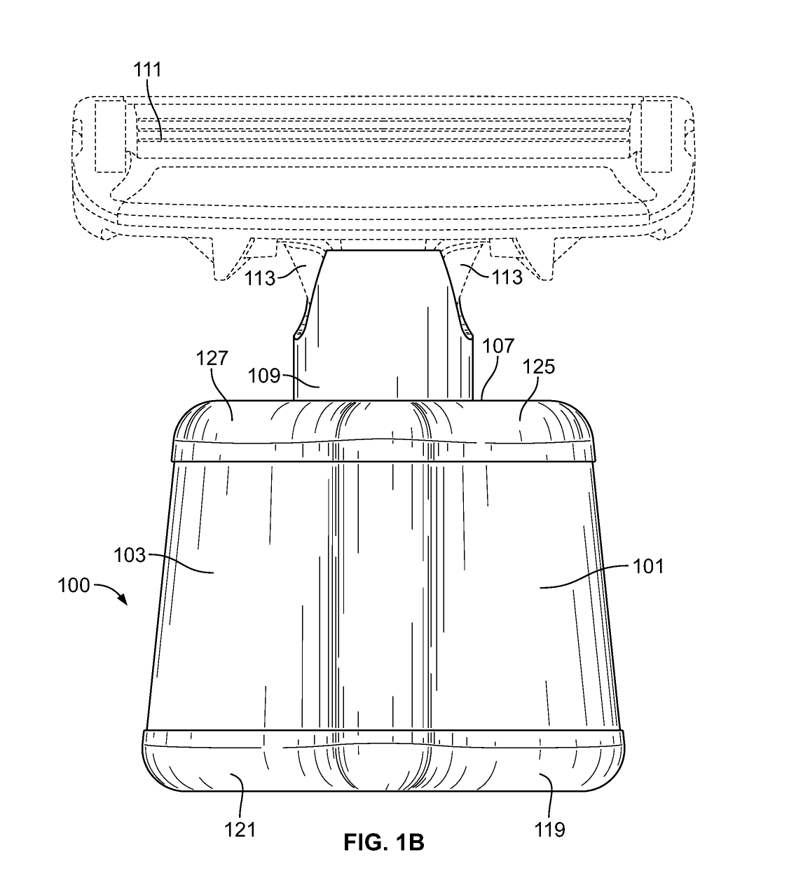

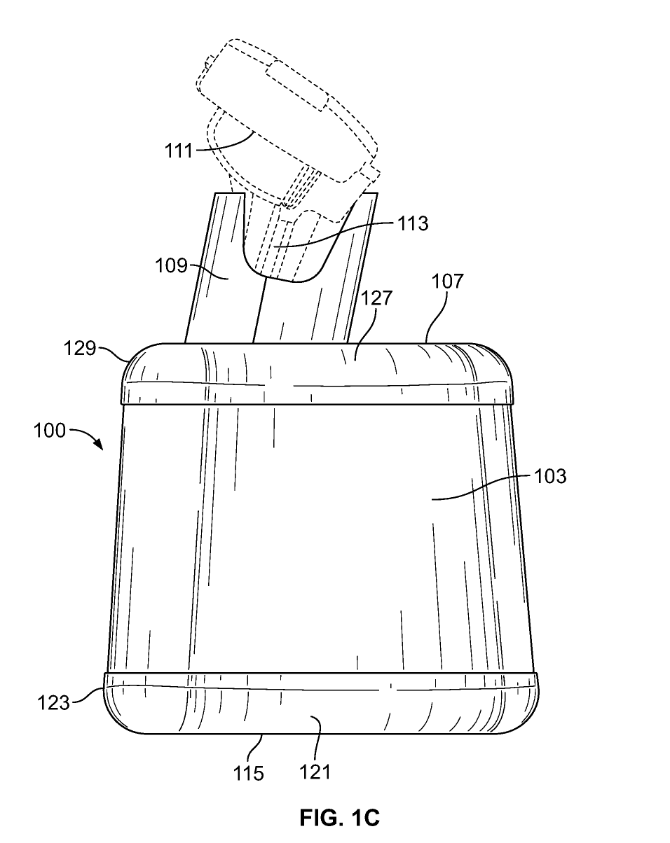

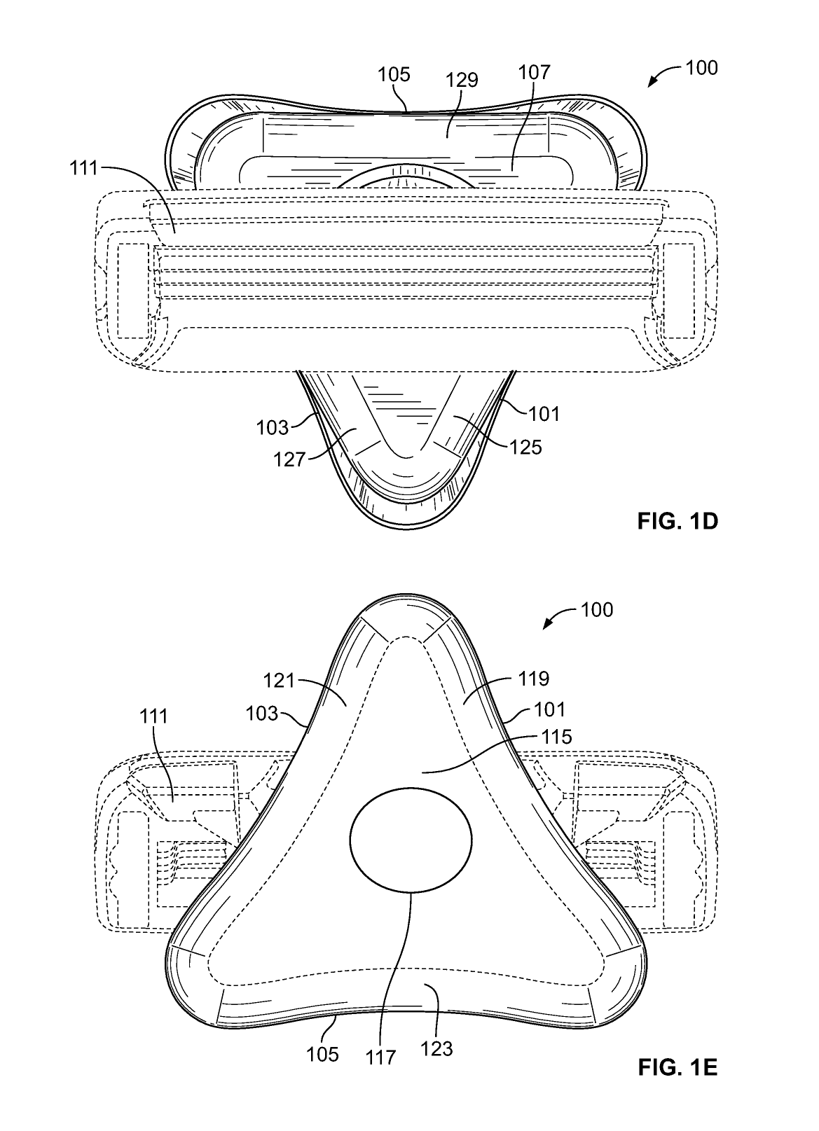

FIGS. 1A-E are various views of a razor handle, according to an embodiment of the invention.

FIG. 1A is a top, front, right side perspective view of the razor handle, according to an embodiment of the invention. FIG. 1B is a front elevation view of the razor handle, according to an embodiment of the invention. FIG. 1C is a left side elevation view of the razor handle, according to an embodiment of the invention. FIG. 1D is a top plan view of the razor handle, according to an embodiment of the invention. FIG. 1E is a bottom plan view of the razor handle, according to an embodiment of the invention.

As shown in FIGS. 1A-E, the razor handle may have a base 100 which includes a top surface 107 for mounting thereon a disposable razor cartridge 111. In certain embodiments, top surface 107 has a substantially triangular shape. Base 100 may also have a bottom surface 115. In certain embodiments, bottom surface 115 has a substantially triangular shape. In certain embodiments, as shown best in FIG. 1C, top surface 107 and bottom surface 115 may be substantially parallel.

As shown FIGS. 1A-E, base 100 preferably has three connected side walls 101,103,105 connected to top surface 107 at upper edges thereof and connected to bottom surface 115 at bottom edges thereof. For the sake of description, as shown best in FIGS. 1A-B, walls 101,103 may be referred to herein as the right and left front walls, respectively, and wall 105 may be referred to herein as the back wall. Each of the three connected side walls 101,103,105 may have a top edge 125,127,129, respectively, at the connection to top surface 107, and a bottom edge 119,121,123, respectively, at the connection to bottom surface 115. Top edges 125,127,129 and bottom edges 119,121,123 may be sharply defined, i.e., as corners, or may be rounded. In addition, the edges between each of connected side walls 101,103,105 may be sharply defined, i.e., as corners, or may be rounded.

In some embodiments of the invention, at least two of the three connected side walls 101,103,105 are of the same size/dimensions as each other. For example, right and left front side walls 101,103 may have the same size/dimensions. In some embodiments of the invention, all three of the three connected side walls 101,103,105 are of the same size/dimensions.

In one embodiment, when disposable razor cartridge 111 is mounted on top surface 107, such that the razor head extends horizontally, one of top edges 125,127,129 may be oriented substantially parallel to mounted razor cartridge 111, and the two others of top edges 125,127,129 may be oriented at an angle with respect to mounted razor cartridge 111. For example, in one embodiment, as shown best in FIGS. 1A-B, back wall 105 may be oriented parallel to mounted razor cartridge 111, and right and left front walls 101,103, respectively, may be oriented at an angle with respect to mounted razor cartridge 111.

In some embodiments of the invention, side walls 101,103,105 are substantially flat. In some embodiments of the invention, side walls 101,103,105 are concave shaped, to allow gripping by a user's fingers, as will be discussed hereinbelow. In some embodiments of the invention, top edges 125,127,129 and bottom edges 119,121,123 of side walls 101,103,105, respectively, are concave.

In some embodiments of the invention, base 100 has a triangular prism shape. In this embodiment, each side of the triangular bottom surface 115 of base 100 has the same dimension as the corresponding side of the triangular top surface 107 of base 100, and side walls 101,103,105 of base 100 may be substantially orthogonally oriented with respect to both top surface 107 and bottom surface 115 of base 100. As such, bottom edges 119,121,123 of each of side walls 101,103,105 of base 100 may have substantially the same lengths as the corresponding top edges 125,127,129 thereof, such that each of side walls 101,103,105 has a square or a rectangular shape, with its respective top edge 125,127,129 and its respective bottom edge 119,121,123 having substantially the same length. In some embodiments of the invention, side walls 101,103,105 have a rectangular shape. In some embodiments of the invention, side walls 101,103,105 have a square shape. In certain embodiments, bottom edges 119,121,123 and top edges 125,127,129 of all of side walls 101,103,105 of base 100 may have substantially the same lengths. In certain embodiments, top surface 107 and bottom surface 115 are substantially parallel to each other.

In some embodiments of the invention, base 100 has a tetrahedral frustum shape, meaning the shape of a tetrahedron whose point has been truncated (truncated tetrahedron). In one such tetrahedral frustum embodiment, as shown in FIGS. 1A-C, side walls 101,103,105 slope inward from the bottom surface 115 of base 100 to the top surface 107 thereof, such that side walls 101,103,105 of base 100 are oriented at an obtuse angle with respect to top surface 107 and at an acute angle with respect to bottom surface 115 of base 100. In this embodiment, each side of the triangular bottom surface 115 of base 100 may be longer than the corresponding side of the triangular top surface 107 of base 100, and bottom edges 119,121,123 of each of side walls 101,103,105 of base 100 may be longer than the corresponding top edges 125,127,129 thereof. In certain embodiments, top surface 107 and bottom surface 115 may be substantially parallel to each other, and thus each of the three side walls 101,103,105 may have a trapezoid shape.

In another such tetrahedral frustum embodiment, side walls 101,103,105 slope outward from the bottom surface 115 of base 100 to the top surface 107 thereof, such that side walls 101,103,105 of base 100 are oriented at an acute angle with respect to top surface 107 and at an obtuse angle with respect to bottom surface 115 of base 100. In this embodiment, each side of the triangular top surface 107 of base 100 may be longer than the corresponding side of the triangular bottom surface 115 of base 100, and bottom edges 119,121,123 of each of side walls 101,103,105 of base 100 may be shorter than the corresponding top edges 125,127,129 thereof. In certain embodiments, top surface 107 and bottom surface 115 may be substantially parallel to each other, and thus each of the three side walls 101,103,105 may have a trapezoid shape.

In some embodiments of the tetrahedral frustum embodiment, side walls 101,103,105 of base 100 make a slow transition from bottom surface 115 of base 100 to top surface 107 thereof, such that the angles at which side walls 101,103,105 are oriented with respect to top surface 107 and with respect to bottom surface 115 are relatively close to 90°. For example, in the first tetrahedral frustum embodiment discussed above, as seen best in FIGS. 1B-C, side walls 101,103,105 of base 100 are oriented at an internal acute angle of approximately 60-89° with respect to bottom surface 115 and are oriented at an internal obtuse angle of approximately 91-120° with respect to top surface 107. Thus, base 100 has a relatively large dimension of height (defined as the distance from bottom surface 115 of base 100 to the top surface 107 thereof) when compared to the size of bottom surface 115 and top surface 107.

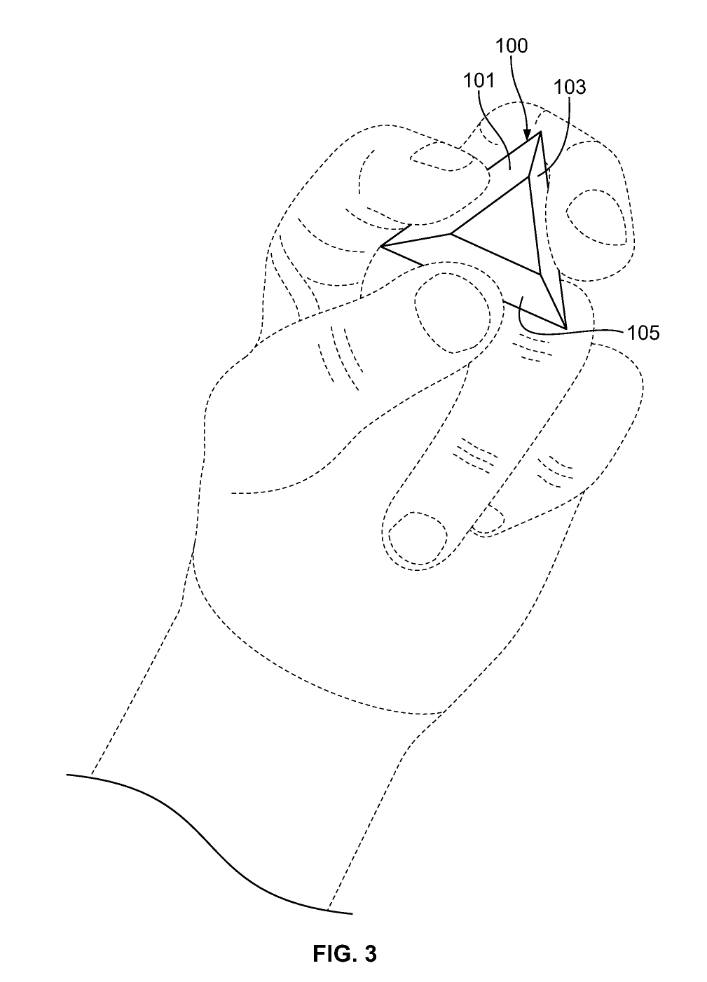

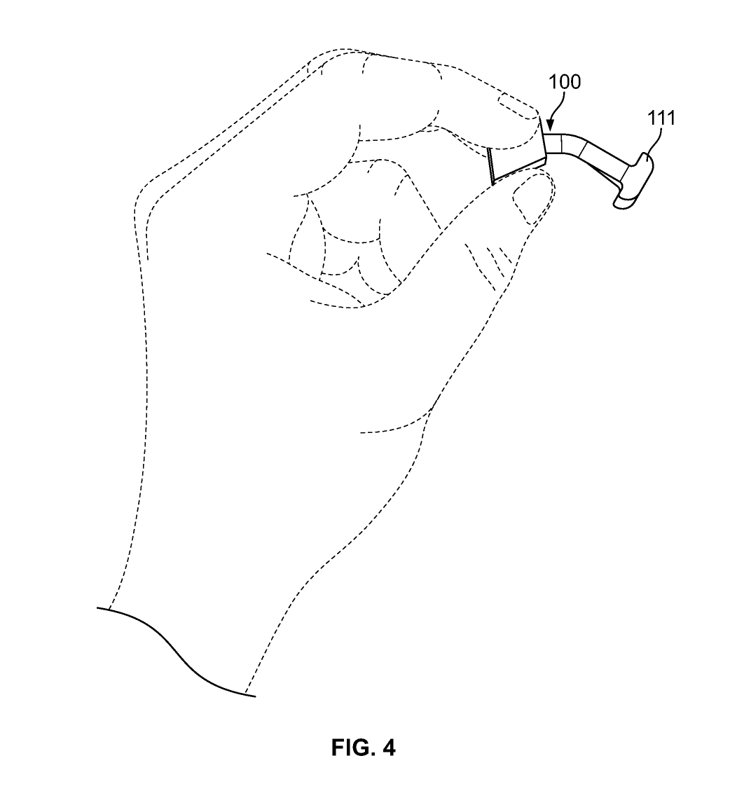

In other embodiments of the tetrahedral frustum embodiment, side walls 101,103,105 of base 100 make a quick transition from bottom surface 115 of base 100 to top surface 107 thereof, such that the angles at which side walls 101,103,105 are oriented with respect to top surface 107 and with respect to bottom surface 115 are relatively substantially smaller than 90°, e.g., closer to 45°. For example, in the first tetrahedral frustum embodiment discussed above, as seen in FIGS. 3 and 4, side walls 101,103,105 of base 100 are oriented at an internal acute angle of approximately 40-59° with respect to bottom surface 115 and are oriented at an internal obtuse angle of approximately 50-130° with respect to top surface 107. Thus, base 100 has a relatively small dimension of height when compared to the size of bottom surface 115 and top surface 107.

In some embodiments of the invention, handle base 100 may be used with a razor, a safety razor or a disposable safety razor cartridge 111, and the razor may be attached to handle base 100 in a variety of ways, such as known in the art. As mentioned above and as shown in FIGS. 1A-E, when disposable razor cartridge 111 is attached to the handle, it may be mounted on top surface 107 of base 100. In some embodiments of the invention, base 100 and razor cartridge 111 are configured as one unitary piece or as separate pieces that are not intended to be separated during use.

In some embodiments of the invention, base 100 and razor cartridge 111 are configured as separate pieces that are intended to be separated during use. In one such embodiment, razor cartridge 111 may be disposable or exchangeable with another such razor cartridge 111, and razor cartridge 111 may be mounted onto base 100 by way of a connecting means 113 that is configured to selectively retain razor cartridge 111 or release razor cartridge 111.

In some embodiments of the invention, top surface 107 may also include a collar 109 that extends upwards away from top surface 107 of base 100 and is configured to substantially surround connecting means 113 that extends upward from base 100 through top surface 107 to grasp razor cartridge 111.

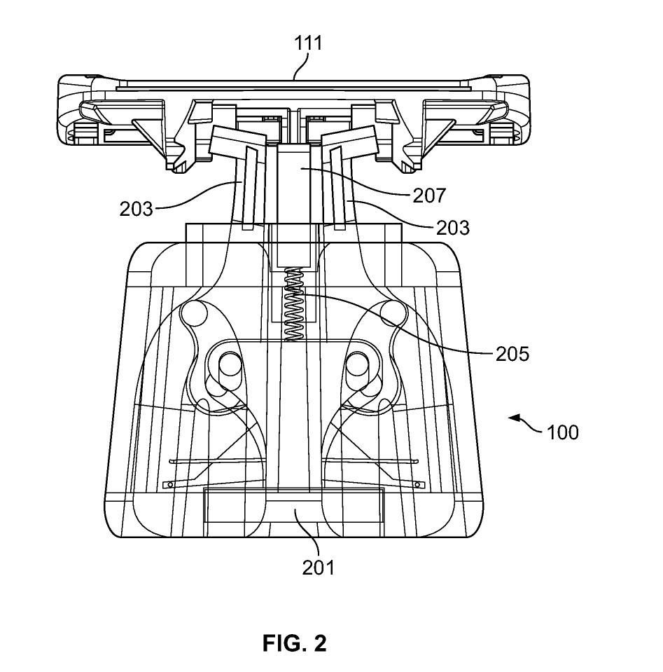

In some embodiments of the invention, connecting means 113 may be manipulated to engage or disengage the disposable razor cartridge 111, causing connecting means 113 to selectively grasp or release, respectively, razor cartridge 111. In certain embodiments, as shown in FIG. 2, base 100 may further comprise a release mechanism 200 for manipulating connecting means 113. In some embodiments of the invention, release mechanism 200 is situated inside base 100. In some embodiments of the invention, release mechanism 200 has a user-manipulatable actuator button 117 located on bottom surface 115 of base 100 to control release mechanism 200.

In certain embodiments, release mechanism 200 may be actuated by a user via actuator button 117 to cause connecting means 113 to release disposable razor cartridge 111 from its grasp, thereby releasing disposable razor cartridge 111 from its mounted position on base 100 and allowing one razor cartridge 111 to be exchanged for another razor cartridge 111 on connecting means 113.

Release mechanism 200 may comprise any appropriate release mechanism as may be known to those of ordinary skill in the art. Examples of such acceptable mechanisms are shown in U.S. Patent Application Publication No. 2002/0116831 (Coffin) and U.S. Pat. No. 6,421,925 (Wonderley), which are incorporated herein by reference. FIG. 2 shows an example of another such release mechanism 200 according to an embodiment of the invention.

In one non-limiting embodiment of the invention, as shown in FIG. 2, release mechanism 200 includes an actuator rod 201, two male connector arms 203, a spring 205, and an ejector column 207. The actuator rod 201 may be connected to the two connector arms 203 and to spring 205. Spring 205 may be connected to actuator rod 201 at its lower end and to ejector column 207 at its upper end. In certain embodiments, connecting means 113, by way of which razor cartridge 111 may be mounted onto base 100, comprises male connector arms 203 and ejector column 207, as well as other parts as described hereinbelow.

In some embodiments of the invention, razor cartridge 111 is mounted on a pin bearing defining a pivot axis about which the head of razor cartridge 111 travels in an arc of about +/−24 degrees about a rest position. In some embodiments of the invention, the connecting means 113 may employ a plurality of tabs and/or posts to attach the razor cartridge 111 to connector arms 203.

In some non-limiting embodiments of the invention, the upper ends of connector arms 203 may comprise relatively moveable engagement projections which are each configured to grasp at least one complimentarily-shaped engagement recess on the underside of the razor cartridge 111. In this embodiment, the engagement projections may move relative to one another in response to depression of the actuator button 117. The connecting means 113 may also include a male part comprising a bifurcated end which positively engages with a receiving recess of a female part. The receiving recess may include a tapered entrance which guides the bifurcated ends of the male part towards each other as the male part is snapped into the female part, and the tapered entrance may lead to a wider part into which the bifurcated ends of the male part can expand to retain the male and female parts in situ. The bifurcated ends of the male part may additionally comprise a vertical projection which engages with a slot of the female part of the connecting means 113 for proper alignment with respect thereto.

In some embodiments of the invention, the two male connector arms 203 may be rotatably mounted inside base 100, such that razor cartridge 111 may be released when the male connector arms 203 are caused to rotate towards or away from each other. In one such embodiment, as shown in FIG. 2, each of connector arms 203 is pivotally mounted within the base 100 by means of a transverse link having a pivot axis. In this embodiment, the lower ends of connector arms 203 may be movably linked to actuator rod 201 by means of a first and second linkage mechanism at respective ends of the two connector arms 203. For example, each linkage mechanism may comprise a link arm depending from a respective connector arm 203, and the link arms may be biased against a transverse extension of actuator rod 201 at a respective side thereof.

Release mechanism 200 may also have a release button (e.g., actuator button 117 depicted in FIG. 1E) located on bottom surface 115 of base 100. Pushing actuator button 117 may cause actuator rod 201 to move upward, such that connector arms 203 are rotatably moved inside base 100, causing the upper ends of connector arms 203 to rotate towards or away from each other to thereby disengage from or release their hold on razor cartridge 111. Upward movement of actuator rod 201 may also cause spring 205 to contract and put pressure on ejector column 207, which applies an upward force on the underside of razor cartridge 111, i.e., in a direction away from base 100, thereby releasing disengaged razor cartridge 111 from connecting means 113. When the pressure on the actuator button 117 is released, the spring 205 may expand and push the parts of release mechanism 200 bask to their initial positions.

Once a shaving blade or disposable razor blade cartridge 111 is attached to razor handle base 100, the entire apparatus may be used manually by a person wishing to remove hair from any part of his or her body. FIGS. 3 and 4 show an illustrative example of how a user may grasp razor handle base 100, according to an embodiment of the invention. FIG. 3 illustratively shows razor handle base 100 without collar 109, connecting means 113 and razor cartridge 111 being gripped by a user, and FIG. 4 shows a side view of a user gripping a razor handle with its attached razor cartridge, according to an embodiment of the invention.

In the embodiments shown, the handle may be held between the tips of a user's index finger, thumb and middle fingers, and then used to shave. FIG. 3 shows how the surface of each of side walls 101,103,105 is gripped by a tip of one of the user's three fingers, namely the thumb, the index finger, and the middle finger. In the embodiment shown, for example where back wall 105 is oriented parallel to mounted razor cartridge 111 and right and left front walls 101,103, respectively, are oriented at an angle to mounted razor cartridge 111, base 100 is gripped by the user pressing the thumb against back side wall 105, pressing the index finger against left front side wall 103, and pressing the middle finger against right front side wall 101. Since there are only three contact or gripping surfaces, namely side walls 101,103,105 on base 100 of the razor handle, it is difficult for the user to hold base 100 incorrectly and for the user's hand to slip of base 100 during use.

Base 100 naturally stands upright on bottom surface 115 when it is not in use, which allows air to circulate around the shaving edge(s) of the blade(s) and allows water to drip away. This facilitates shorter drying times and reduces the likelihood of an expedited deterioration of the blade's shaving edge due to extended contact with water and other elements.

This invention can be cast or molded to form its shape, and then coated, or covered with a form of rubber-like material to prevent slippage. This allow base 100 to conform to the user's fingertips when gripped firmly. In some embodiments of the invention, a resiliently deformable element is disposed on at least one of side walls 101,103,105 of base 100. The resiliently deformable element may be adapted, in use, to exert a gripping pressure or force on the user's fingers. The resiliently deformable element may be manufactured of a high friction material, such as rubber, to facilitate gripping the base 100 when wet or soapy.

In addition, whereas in some embodiments, side walls 101,103,105 are substantially flat, in other embodiments, side walls 101,103,105 are concave shaped to allow gripping by the user's fingers. In some such embodiments, as seen best in FIGS. 1A, 1D and 1E, top edges 125,127,129 and bottom edges 119,121,123 of side walls 101,103,105, respectively, are concave. FIGS. 1A, 1D and 1E show certain embodiments of base 100, in which side walls 101,103,105 and/or their respective top edges 125,127,129 and bottom edges 119,121,123 have only a small concavity, i.e., a relatively small depression therein to aid in gripping by the user's fingers. In other embodiments of base 100, side walls 101,103,105 and/or their respective top edges 125,127,129 and bottom edges 119,121,123 have a larger concavity, i.e., a relatively large depression therein to aid in gripping by the user's fingers.

As discussed previously, top edges 125,127,129 and bottom edges 119,121,123 may be sharply defined, i.e., as corners, or may be rounded, and the edges between each of connected side walls 101,103,105 may be sharply defined, i.e., as corners, or may be rounded.

In the above description, an embodiment is an example or implementation of the inventions. Different embodiments are disclosed herein. The various appearances of “one embodiment”, “an embodiment”, “certain embodiments” or “some embodiments” do not necessarily all refer to the same embodiments.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Features of certain embodiments may be combined with features of other embodiments; thus, certain embodiments may be combinations of features of multiple embodiments.

Furthermore, it is to be understood that the invention can be carried out or practiced in various ways and that the invention can be implemented in embodiments other than the ones outlined in the description above.

It is to be understood that the details set forth herein do not construe a limitation to an application of the invention and that the phraseology and terminology employed herein is not to be construed as limiting and are for descriptive purpose only. Similarly, the descriptions, examples, methods and materials presented in the claims and the specification are not to be construed as limiting but rather as illustrative only.

It is to be understood that where the specification states that a component, feature, structure, or characteristic “may”, “might”, “can” or “could” be included, that particular component, feature, structure, or characteristic is not required to be included.

While the invention has been described with respect to a limited number of embodiments, these should not be construed as limitations on the scope of the invention, but rather as exemplifications of some of the preferred embodiments. Other possible variations, modifications and applications are also within the scope of the invention. Accordingly, the scope of the invention should be limited not by what has thus far been described but by the appended claims and their legal equivalents.

1. A razor handle comprising:
a base having three connected side walls and a triangular top surface for mounting a razor cartridge.

2. The razor handle of claim 1, wherein at least two of the three side walls are the same size.

3. The razor handle of claim 2, wherein all three side walls are the same size.

4. The razor handle of claim 1, wherein said base has a tetrahedral frustum shape.

5. The razor handle of claim 4, wherein:
each of the three side walls has a bottom edge and a top edge; and
the bottom edge of each of the three side walls is longer than the top edge of each of the three side walls.

6. The razor handle of claim 4, wherein:
said base comprises a triangular bottom surface; and
each side of the triangular bottom surface is larger than the corresponding side of the triangular top surface.

7. The razor handle of claim 4, wherein each of the three side walls has a trapezoid shape.

8. The razor handle of claim 1, wherein said base has a triangular prism shape.

9. The razor handle of claim 8, wherein at least one of the three side walls has a square shape.

10. The razor handle of claim 8, wherein at least one of the three side walls has a rectangular shape.

11. The razor handle of claim 8, wherein:
said base comprises a triangular bottom surface that is substantially the same size as the triangular top surface.

12. The razor handle of claim 1, wherein each of the three walls of said base has a concave surface to aid in gripping by a user.

13. The razor handle of claim 1, wherein at least one of the three sides comprises a high friction material disposed thereon.

14. The razor handle of claim 1, wherein each of the side walls forms an edge with another of the side walls, wherein the edges are either sharply defined or are rounded.

15. The razor handle of claim 1, wherein the base comprises a mechanism therein for allowing the razor cartridge to be selectively retained and released.

16. The razor handle of claim 15, further comprising a connecting means for grasping the razor cartridge.

17. The razor handle of claim 16, wherein the connecting means extends from the top surface of said base.

18. The razor handle of claim 16 further comprising a release button that, when pushed, causes the razor cartridge to be released from said connecting means.

19. The razor handle of claim 18, wherein the release button is located on a bottom surface of said base.
